(19) United States
(12) Patent Application Publication
(10) Pub. No.: US 2004/0117350 A1
(43) Pub. Date: Jun. 17, 2004

(54) Apparatus and method for optimizing schema definitions for an LDAP directory

(75) Inventors: Mark Joseph Cavage, Austin, TX (US); Gary Dale Williams, Driftwood, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY

(21) Appl. No.: 10/318,000

(22) Filed: Dec. 12, 2002

(51) Int. Cl. G06F 17/30

(52) U.S. Cl. 707/2

(57) ABSTRACT

An apparatus and method for optimizing the schema definitions of an LDAP directory. With the apparatus and method, a required object class file is generated that sets forth the object classes required by a client device's applications. This file is then compared against the schema definitions in an LDAP directory server. Those schema definitions that reference the object classes in the required object class file are logged along with any superior classes of these object classes. Similarly, the attributes of these schema definitions and their superior attributes are also logged. The logged schema definitions and attributes are then stored as a reduced set of schema definitions in associated with a client device identifier. Thereafter, when the client device requests an LDAP directory operation, the reduced set of schema definitions is loaded and used rather than the entire set of LDAP directory schema definitions.

### BACKGROUND OF THE INVENTION

1. Technical Field

The present invention is directed to an apparatus and method for optimizing schema definitions for an LDAP directory. More specifically, the present invention is directed to a mechanism for generating a reduced set of schema definitions for use with a specific LDAP directory.

2. Description of Related Art

Directory services provide methods for storing, modifying and querying data in a standards-defined manner. In order to meet these standards, schema have been defined by the International Engineering Task Force (IETF). Schema are collections of attribute type definitions, object class definitions and other information which a server uses to determine how to match a filter or attribute value assertion (in a compare operation) against the attributes of an entry, and whether to permit add and modify operations.

Generally, directory enabled applications require an application-specific set of schema definitions. This is not a problem in itself, however, as more applications are developed and bundled with a directory offering, the cumulative schema definitions can become many times larger than is required by a typical user. It is probable that the user's data will only require a small subset of the total number of schema definitions available. That is, an Lightweight Directory Access Protocol (LDAP) directory may have hundreds or thousands of schema definitions yet a user's data may only make use of less than one hundred of those schema definitions.

The overhead required in maintaining a large set of schema definitions affects the LDAP directory server and clients. The large set of schema definitions takes more time to parse and load during start up of an LDAP server. The representation in memory requires more space. There is more network traffic when a client requests that the set of schema definitions be downloaded and any client which stores a copy of the schema definitions will also need more space. Most significantly, however, any operation that updates the directory data will require much more time to complete, since schema checking is always performed before the data is updated.

Since the LDAP directory server is a key component of many middleware products, performance problems in the directory server will degrade the entire system. An improvement in directory performance will be seen as an improvement in the performance of these middleware systems. Since the poor performance of update operations is directly proportional to the size of the set of schema definitions, it would be beneficial to reduce the size of the set of schema definitions used in an LDAP directory while still providing the required number of schema definitions for implementing the LDAP directory for particular users. Thus, it would be beneficial to have an apparatus and method for optimizing the set of schema definitions used in an LDAP directory server.

### SUMMARY OF THE INVENTION

The present invention provides an apparatus and method for optimizing the schema definitions of an LDAP directory. With the apparatus and method of the present invention, a required object class file is generated that sets forth the object classes required by a client device's applications. This file is then compared against the schema definitions in an LDAP directory server. Those schema definitions that reference the object classes in the required object class file are logged along with any superior classes of these object classes. Similarly, the attributes of these schema definitions and their superior attributes are also logged.

The logged schema definitions and attributes are then stored as a reduced set of schema definitions in associated with a client device identifier. Thereafter, when the client device requests an LDAP directory operation, the reduced set of schema definitions is loaded and used rather than the entire set of LDAP directory schema definitions.

These and other features will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which the present invention may be implemented;

FIG. 2 is an exemplary diagram of a server computing device that may be used as an LDAP server in accordance with the present invention;

FIG. 3 is an exemplary diagram of a client device that may be used with an LDAP directory server in accordance with the present invention;

FIG. 4 is an exemplary block diagram of the primary operational components of an LDAP directory in accordance with the present invention;

FIG. 5 is a flowchart outlining an exemplary operation of the present invention for generating a reduced set of LDAP directory schema definitions; and

FIG. 6 is a flowchart outlining an exemplary operation of the present invention for generating a set of attributes to be included in the reduced set of LDAP directory schema definitions.

### DETAILED DESCRIPTION OF THE PREFERRED EMBODIMENT

The present invention provides an apparatus and method for optimizing schema definitions in an LDAP directory. As such, the present invention is implemented in an LDAP directory server computing device which is part of a distributed data processing system. Therefore, a brief explanation of a distributed data processing environment will first be provided in order to give a context to the description of the preferred embodiment of the present invention.

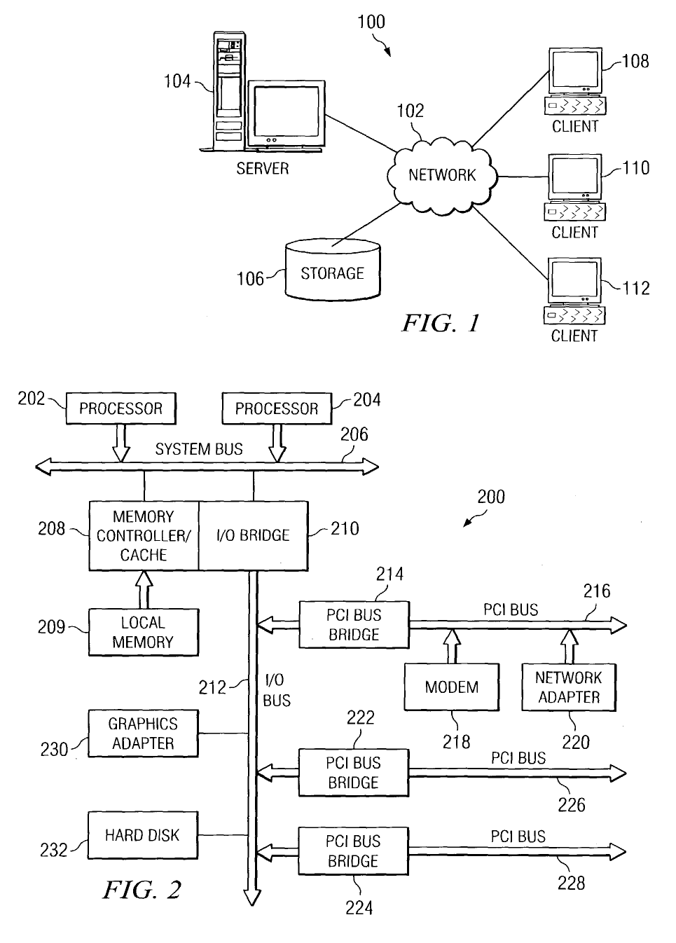

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers.

In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

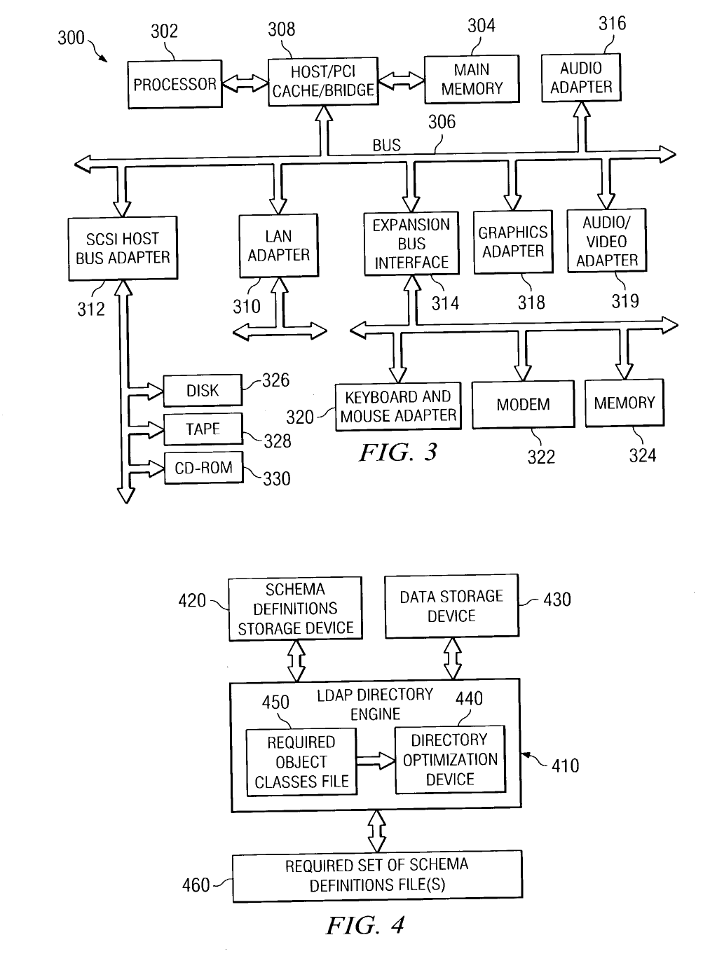

The data processing system depicted in FIG. 2 may be, for example, an IBM eServer pSeries system, a product of International Business Machines Corporation in Armonk, N.Y., running the Advanced Interactive Executive (AIX) operating system or LINUX operating system. with reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned previously, the present invention provides a mechanism for generating an optimized set of schema definitions for use with an LDAP directory. with the apparatus and method of the present invention, a required object class file is generated that sets forth the object classes required by a client device's applications. This file is then compared against the schema definitions in an LDAP directory server. Those schema definitions that reference the object classes in the required object class file are logged along with any superior classes of these object classes. Similarly, the attributes of these schema definitions and their superior attributes are also logged. The logged schema definitions and attributes are then stored as a reduced set of schema definitions in associated with a client device identifier. Thereafter, when the client device requests an LDAP directory operation, the reduced set of schema definitions is loaded and used rather than the entire set of LDAP directory schema definitions.

FIG. 4 is an exemplary block diagram of the primary operational components of an LDAP directory in accordance with the present invention. As shown in FIG. 4, the LDAP directory includes an LDAP directory engine 410, a schema definition data storage 420, and a data storage 430. The LDAP directory engine 410 includes a directory optimization device 440 and a required object classes file 450. The required object classes file 450 may in fact include a plurality of files that are established for different client devices.

The required object classes file 450 may be generated by a user of a client device. The required object classes file 450 may then be uploaded to the LDAP directory server for use with the present invention in generating a reduced set of schema definitions that is to be used with LDAP directory operation requests from that client device.

The required object classes file 450, in a preferred embodiment, is an LDAP Data Interchange Format (LDIF) file that contains enough data to serve as a complete representation of the object classes required by the user's portion of data in the data storage 430 of the LDAP directory. More information about LDIF may be obtained from RFC 2849. The key concept with regard to the required object classes file 450 is that it provides a complete listing of object classes used by applications present on the client device. As such, when new applications are added to the client device, a new required object classes file 450 may be uploaded to the LDAP directory server for use in generating an updated reduced set of schema definitions for the client device.

With the present invention, the directory optimization device 440 reads in the required object classes file 450 for the client device and uses this file as a basis for identifying which ones of the schema definitions in the schema definition data storage 420. For each object class set forth in the required object classes file 450, the directory optimization device 440 searches the schema definitions in the schema definitions data storage 420 for schema definitions that include the required object class. Those schema definitions that include the required object class are logged for use in generating the required set of schema definitions file(s) 460. The attributes of those schema definitions are also logged.

Since there is a hierarchy to object classes and attributes, in addition to logging the schema definitions and attributes associated with the required object classes, all schema definitions and attributes that are “parents” of the required object classes and attributes must be logged as well. Thus, the present invention traverses the hierarchy from the required object classes and attributes upward through each superior and logs those schema definitions referencing superior object classes and logs superior attributes for those attributes referenced in the required schema definitions. With attributes, however, only unique attributes are logged. That is, if the attribute has been previously logged, it is not logged again.

Once all of the required object classes in the required object classes file 450 are searched using the directory configuration device 440, the logged schema definitions and attributes are stored as a required set of schema definition file(s). When the LDAP directory engine 410 receives a request for an LDAP directory operation from the client device, rather than using the entire set of schema definitions stored in the schema definitions data storage 420, the required set of schema definitions file(s) 460 are used to perform the LDAP directory operation. In this way, a much smaller set of schema definitions is accessed. Thus, the performance of the LDAP server is increased due to the need to access a much smaller set of schema definitions.

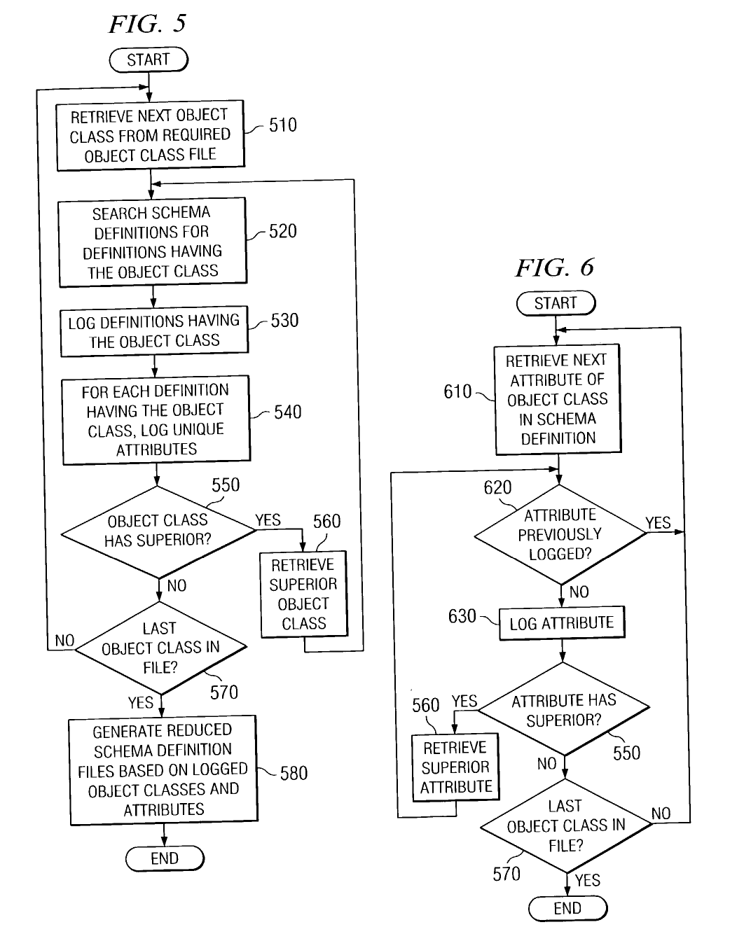

FIG. 5 is a flowchart outlining an exemplary operation of the present invention for generating a reduced set of LDAP directory schema definitions. As shown in FIG. 5, the operation starts with retrieving a next object class from the required object class file (step 510). The schema definitions are then searched for definitions having the object class reference in them (step 520). Those schema definitions that reference the required object class are logged (step 530).

For each of the schema definitions that are logged, unique attributes referenced in those schema definitions are also logged (step 540). A determination is then made as to whether the object class has a superior object class (step 550). If so, the superior object class is retrieved (step 560) and the operation returns to step 520.

If there is no superior object class, a determination is made as to whether the object class is the last object class in the required object class file (step 570). If not, the operation returns to step 510. If this is the last object class in the required object class file, the reduced required schema definition files are generated based on the logged schema definitions and attributes (step 580).

FIG. 6 is a flowchart outlining an exemplary operation of the present invention for generating a set of attributes to be included in the reduced set of LDAP directory schema definitions. As shown in FIG. 6, the operation starts by retrieving the next attribute of the object class in the schema definition (step 610). A determination is then made as to whether the attribute has been previously logged (step 620). If so, the operation returns to step 610. If the attribute has not been previously logged, the attribute is logged (step 630).

Thereafter, a determination is made as to whether the attribute has a superior (step 640). If so, the superior attribute is retrieved (step 650) and the operation returns to step 620. If the attribute does not have a superior, a determination is made as to whether this is the last attribute for the object class (step 660). If not, the operation returns to step 610. Otherwise, the operation ends.

The present invention has been applied to the IBM Directory Server version 5.1. This directory server has an entire schema definition set that contains 332 object classes and 2,536 attribute type definitions. An LDIF file having 50 entries containing typical corporate object class structures was developed. This LDIF file contained 13 object classes and 132 attribute type definitions. Performance statistics were measured on both sets of schema and the time (in seconds) is provided in Table 1 below as well as the improvement gained by the minimum schema generated by the present invention.

TABLE 1
Performance Comparison of Present
Invention to Conventional LDAP

| | Complete | Minimum | |
|---|---|---|---|
| | Schema | Schema | Improvement |
| Server start | 25 | 22 | 12% |
| time | | | |
| Load sample | 16 | 113 | 19% |
| data | | | |
| Modify sample | 26 | 24 | 8% |
| data | | | |
| Search entire | 1.7 | 0.8 | 53% |
| sample suffix | | | |
| (dns only) | | | |
| Delete entire | 13 | 10 | 24% |
| sample suffix | | | |
| Search entire | 29 | 5 | 83% |
| schema | | | |
| Add attribute | 1.7 | 0.6 | 64% |
| definition | | | |

It is clear from the above table that using the minimum schema generated from the use of the present invention resulted in a performance improvement in all cases, some by as much as 83%. The operations pertaining to schema operations were impacted the most. However, it is also very important to note that the average performance increase was roughly 37% in the above cases. Thus, the present invention provides a mechanism for increasing the performance of LDAP servers by reducing the size of the schema definitions that the LDAP servers must access when performing LDAP operations for client devices.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of optimizing the performance of a directory server having a first listing of a plurality of schema definitions that may be used to access data on the directory server, comprising:
receiving a listing of required object classes for a client;
comparing the listing of required object classes to the first listing of schema definitions stored in the directory server;
generating a second listing of schema definitions based on the comparison of the listing of required object classes to the first listing of schema definitions; and
storing the second listing of schema definitions in association with an identifier of the client.

2. The method of claim 1, wherein the second listing of schema definitions has less schema definitions than the first listing of schema definitions.

3. The method of claim 1, wherein the second listing of schema definitions has only those schema definitions from the first listing of schema definitions that reference a required object class or a parent of a required object class.

4. The method of claim 1, further comprising;
receiving a request for access to data stored on the directory server; and
using the second listing of schema definitions to provide the access to the data.

5. The method of claim 1, wherein the directory server is a lightweight directory access protocol (LDAP) directory server.

6. The method of claim 1, wherein generating a second listing of schema definitions based on the comparison of the listing of required object classes to the first listing of schema definitions includes:
identifying attributes of schema definitions to be included in the second listing of schema definitions; and
storing the attributes and any parent attributes of the attributes in the second listing of schema definitions.

7. The method of claim 6, wherein storing the attributes includes:
determining if the an attribute has been previously stored in the second listing of schema definitions, wherein if the attribute has been previously stored in the second listing of schema definitions, it is not stored again in the second listing of schema definitions.

8. The method of claim 1, wherein the listing of required object classes is received in response to a change in the applications used by the client.

9. A computer program product in a computer readable medium for optimizing the performance of a directory server having a first listing of a plurality of schema definitions that may be used to access data on the directory server, comprising:
first instructions for receiving a listing of required object classes for a client;
second instructions for comparing the listing of required object classes to the first listing of schema definitions stored in the directory server;
third instructions for generating a second listing of schema definitions based on the comparison of the listing of required object classes to the first listing of schema definitions; and
fourth instructions for storing the second listing of schema definitions in association with an identifier of the client.

10. The computer program product of claim 9, wherein the second listing of schema definitions has less schema definitions than the first listing of schema definitions.

11. The computer program product of claim 9, wherein the second listing of schema definitions has only those schema definitions from the first listing of schema definitions that reference a required object class or a parent of a required object class.

12. The computer program product of claim 9, further comprising:
fifth instructions for receiving a request for access to data stored on the directory server; and
sixth instructions for using the second listing of schema definitions to provide the access to the data.

13. The computer program product of claim 9, wherein the directory server is a lightweight directory access protocol (LDAP) directory server.

14. The computer program product of claim 9, wherein the third instructions for generating a second listing of schema definitions based on the comparison of the listing of required object classes to the first listing of schema definitions include:
instructions for identifying attributes of schema definitions to be included in the second listing of schema definitions; and
instructions for storing the attributes and any parent attributes of the attributes in the second listing of schema definitions.

15. The computer program product of claim 14, wherein the instructions for storing the attributes include:
instructions for determining if the an attribute has been previously stored in the second listing of schema definitions, wherein if the attribute has been previously stored in the second listing of schema definitions, it is not stored again in the second listing of schema definitions.

16. The computer program product of claim 9, wherein the listing of required object classes is received in response to a change in the applications used by the client.

17. An apparatus for optimizing the performance of a directory server having a first listing of a plurality of schema definitions that may be used to access data on the directory server, comprising:
means for receiving a listing of required object classes for a client;
means for comparing the listing of required object classes to the first listing of schema definitions stored in the directory server;
means for generating a second listing of schema definitions based on the comparison of the listing of required object classes to the first listing of schema definitions; and
means for storing the second listing of schema definitions in association with an identifier of the client.

18. The apparatus of claim 17, wherein the second listing of schema definitions has only those schema definitions from the first listing of schema definitions that reference a required object class or a parent of a required object class.

19. The apparatus of claim 17, further comprising:
means for receiving a request for access to data stored on the directory server; and
means for using the second listing of schema definitions to provide the access to the data.

20. The apparatus of claim 17, wherein the means for generating a second listing of schema definitions based on the comparison of the listing of required object classes to the first listing of schema definitions includes:
means for identifying attributes of schema definitions to be included in the second listing of schema definitions; and
means for storing the attributes and any parent attributes of the attributes in the second listing of schema definitions.
